(19) United States
(12) Patent Application Publication
(10) Pub. No.: US 2023/0302730 A1
(43) Pub. Date: Sep. 28, 2023

(54) DUAL-WAVELENGTH 3D PRINTER WITH PHOTO-INHIBITION

(71) Applicant: DENTSPLY SIRONA Inc., York, PA (US)

(72) Inventors: Christian STAHL, Lorsch (DE); Johannes KRUG, Lorsch (DE)

(73) Assignee: DENTSPLY SIRONA Inc., York, PA (US)

(21) Appl. No.: 17/702,153

(22) Filed: Mar. 23, 2022

(51) Int. Cl. B29C 64/277; G02B 26/08; G02B 27/09; B33Y 10/00; B33Y 30/00; B29C 64/135

(52) U.S. Cl. CPC B29C 64/277; G02B 26/0833; G02B 27/0905; G02B 27/0977; B33Y 10/00; B33Y 30/00; B29C 64/135; B29L 2031/753

(57) ABSTRACT

A 3D printing system that includes a first light source and a second light source. The first light source emits a first light beam having a first wavelength that initiates polymerization of a photosensitive resin and the second light source emits a second light beam having a second wavelength that inhibits polymerization of the photosensitive resin. A dichroic mirror is placed in an optical path of the 3D printing system to superimpose the first and second beams, a digital micromirror device (DMD) spatially structures the superimposed first and second light beams into a spatial pattern as a spatially structured superimposed light beam, and a single optical system in the optical path projects the spatially structured superimposed light beam onto the photosensitive resin.

### TECHNICAL FIELD

The present invention relates generally to a dual-wavelength light engine for DLP 3D printing with photo-inhibition. More particularly, the present invention relates to a setup configured to independently and locally control activation and inhibition of a polymerization process.

### BACKGROUND

A 3D printing apparatus may be used for the manufacturing of a 3D object such as a 3D dental object with a desired shape through exposing a photocurable substance with light that may transform monomers and oligomers of the photocurable substance into polymers. Those polymers may then make up the body of a 3D (three-dimensional) solid.

### SUMMARY

In an aspect a 3D printing system is disclosed. The 3D printing system may comprise a first light source and a second light source combined in one light engine. The light sources may comprise LEDs (light emitting diodes). Light from two LEDs radiating at wavelengths matched for polymerization inhibition and polymerization activation may be mixed by a dichroic mirror before being spatially structured by a digital mirror device (DMD). Behind the DMD, the mixed light mask may be projected to a vat by an optical system comprising one or more lenses.

In an aspect, the 3D printing system may comprise two LEDs emitting different wavelengths, the dichroic mirror combining the light of the two LEDs, the DMD configured to create the irradiation mask and the optical system forming the projection. However the two LEDs or light sources may be combined into one, i.e., one LED or light source may emit two wavelengths.

In an aspect, the irradiation mask may be a patterned illumination that may be projected through a transparent glass window of a vat containing photopolymerizable resin to initiate polymerization of the resin while illumination at a second wavelength may inhibit the polymerization reaction in a layer of adjustable thickness adjacent to the glass window, eliminating adhesion of the solidified layer to the bottom of the vat and enabling continuous operation. The non-adhesion may enable the continuous printing. However, a stepwise printing process is also applicable herein and may benefit from the non-adhesion.

In another aspect, identical irradiation masks may be provided for both wavelengths, i.e., for both the photoinhibition and photopolymerization reactions. Further, the system may require one optics only that forms the image used to illuminate the resin, and the setup may alleviate the problem of lingering inhibition radicals by projecting the structured illumination pattern for the wavelength that causes inhibition to only a confined area corresponding to a cross section or layer of the 3D object being printed.

The wavelengths will depend on the characteristics of the photo-initiator and -inhibitor in the resin, in particular their absorption spectra. Hence, it's a question of matching the characteristics of the resin and the projector system. It is preferable that the emittance spectra of the light sources providing the two wavelengths do not overlap and there may be multiple combinations that work well.

In yet another aspect, a 3D printing system is disclosed. The 3D printing system may comprise a first light source configured to emit a first light beam having a first wavelength, a second light source configured to emit a second light beam having a second wavelength, a dichroic mirror disposed in an optical path of the 3D printing system and configured to superimpose the first and second beams, a digital micromirror device (DMD) configured to spatially structure the superimposed first and second light beams into a spatial pattern as a spatially structured superimposed light beam, and an optical system configured to project the spatially structured superimposed light beam onto a resin disposed in a vat to independently control (by the setting the relative light intensities of the first and second light beams) activation and inhibition of a polymerization process of the resin in first and second volume respectively above a region of the resin defined by the spatial pattern imposed by the DMD. The DMD may be disposed between the dichroic mirror and the optical system.

In another aspect, a method may be disclosed. The method may comprise emitting, by a first light source of a 3D printing system, a first light beam having a first wavelength; emitting, by a second light source, a second light beam having a second wavelength; superimposing, by a dichroic mirror disposed in an optical path of the 3D printing system, the first and second light beams; spatially structuring the superimposed light beams, by a digital micromirror device (DMD) disposed between the dichroic mirror and an optical system, into a spatial pattern as a spatially structured superimposed light beam; and projecting, by the optical system, the spatially structured superimposed light beam onto a resin disposed in a vat to independently control activation and inhibition of a polymerization process of the resin in a first and second volume respectively above a region of the resin defined by the spatial pattern imposed by the DMD.

In yet another aspect, a non-transitory computer readable storage medium may be disclosed. The non-transitory computer readable storage medium may store a program which, when executed by a computer system, causes the computer system to perform a procedure that controls a process executed by the 3D Printing system comprising emitting, by a first light source of a 3D printing system, a first light beam having a first wavelength; emitting, by a second light source, a second light beam having a second wavelength; superimposing, by a dichroic mirror disposed in an optical path of the 3D printing system, the first and second light beams; spatially structuring the superimposed light beams, by a digital micromirror device (DMD) disposed between the dichroic mirror and an optical system, into a spatial pattern as a spatially structured superimposed light beam; and projecting, by the optical system, the spatially structured superimposed light beam onto a resin disposed in a vat to independently control activation and inhibition of a polymerization process of the resin in a first and second volume respectively above a region of the resin defined by the spatial pattern imposed by the DMD.

Further, the wavelengths may be chosen according to the characteristics of the photo-initiator and -inhibitor in the resin, in particular their absorption spectra. In an embodiment, the emittance spectra of the light sources providing the two wavelengths may not overlap or may not overlap significantly and thus a plurality of combinations may be possible. More specifically, not overlapping or not overlapping significantly may mean that, the spectra of the two light sources are well separated or the peak wavelengths with defined tolerances (e.g. tolerances of 3 nm, or 5 nm or 10 nm) are distinct. In an embodiment, a wavelength of about 385 nm (e.g. a peak wavelength of the LED is 385 nm with a tolerance of 3 nm, for example, or 5 nm, or 10 nm″) may be used for the initiation and a wavelength of about 405 nm (e.g. a peak wavelength of the LED is 405 nm with a tolerance of 3 nm, for example, or 5 mm, or 10 nm″) may be used for the inhibition. Further, light sources other than LEDs, such as lamps or lasers may also be used for DLP (digital light processing) projectors. However, light from such sources may be further processed using filters or converters to generate a narrow spectrum around the desired wavelength.

### BRIEF DESCRIPTION OF THE DRAWINGS

To easily identify the discussion of any particular element or act, the most significant digit or digits in a reference number refer to the figure number in which that element is first introduced.

FIG. 1 depicts a block diagram of a 3D printing system in accordance with one or more embodiments.

FIG. 2 depicts a sketch of a part of a 3D printing system in accordance with one or more embodiments.

FIG. 3 illustrates a process 300 in accordance with one embodiment.

FIG. 4 depicts a computer system in accordance with one or more embodiments.

### DETAILED DESCRIPTION

The illustrative embodiments recognize that a user such as dental practitioner may use a 3D printing system to print an object such as a dental object. The object may be printed with an additive manufacturing process which may include techniques such as fused deposition modelling (FDM), selective laser sintering (SLS), stereolithography (SL) and digital light processing (DLP).

In a DLP 3D printing process, a setup may be constructed comprising two independent light sources radiating at different wavelengths, wherein one light source may be a mask projector providing irradiation masks for a curing reaction and a second light source may provide an unstructured light field causing the inhibition reaction. The illustrative embodiments recognize that, because the second light source may provide an unstructured light field only rather than a mask, an inhibition reaction may occur across the full printing area within a layer of resin at the bottom of a vat and not only in the area where material is solidified by the first light source. This may introduce lingering inhibiting radicals, that may limit the achievable printing speed in a continuous printing process. The illustrative embodiments further recognize that for such a setup, two separate light sources may require two independent optics that may have to be aligned.

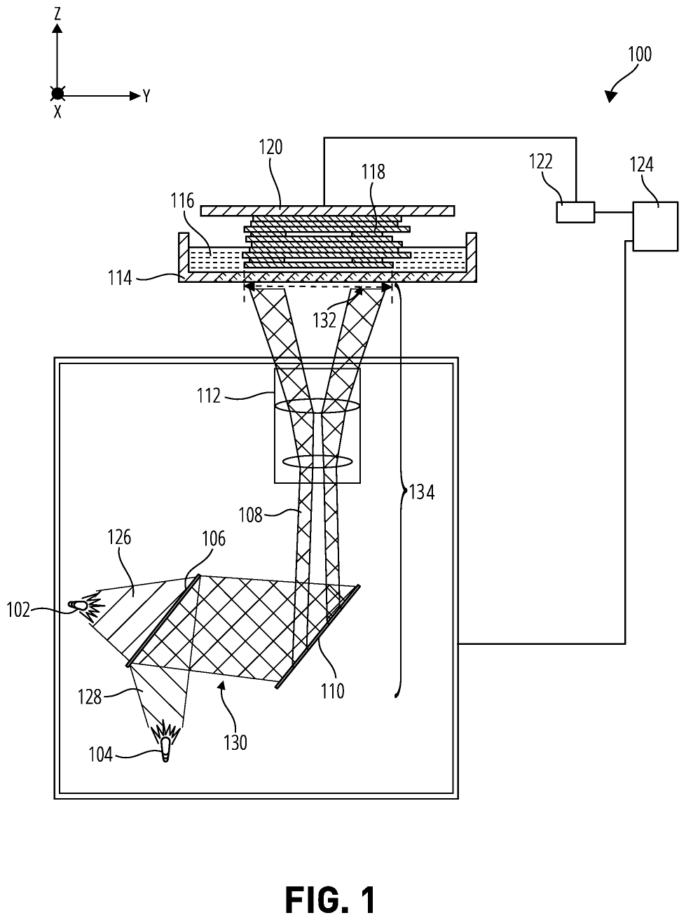

The illustrative embodiments disclose, as shown in FIG. 1, a 3D printing system 100 which employs DLP and comprises a first light source 102 and a second light source 104. The 3D printing system 100 may be a DLP apparatus. The DLP apparatus may contain a digital micromirror device (DMD) which is an array of reflective micromirrors. The DMD may be an optical output micro-electrical-mechanical system (MEMS) that may allow the performance of high speed, efficient, and reliable spatial light modulation. Each DMD may contain, for example, up to 8 million individually controlled micromirrors built on top of an associated CMOS memory cell. During operation, a DMD controller may load each underlying memory cell with a ‘1’ or a ‘0’. A mirror reset pulse may be applied, which may cause each micromirror to be electrostatically deflected about a hinge to an associated +/−degree state. The deflection angle of these two valid states may be repeatable. The +degree state may correspond to an ‘on’ pixel, and the − degree state may correspond to an ‘off’ pixel. Variations of these may be possible. In alternative embodiments, pixel-based displays that create digital masks, or laser beams may be used. In the 3D printing system 100, layered images, particularly pixel-based layered images, may be projected into a reference surface in the photocurable resin to harden it stepwise or continuously. The reference surface may be defined through the focal plane of the projected image in which the curing of the photocurable substance/resin is supposed to occur and a cured layer is formed. Depending on the application, the cured layer may have a rigid or flexible consistency and is generally located on the bottom of a vat containing the photocurable substance. The first cured layer produced in the printing process may be attached, through adhesion in a polymerization process, to a platform 120 which may be relatively movable with respect to the vat 114. During the exposure, the cured layer may be prevented from sticking to the bottom of the vat 114 through photoinhibition as described hereinafter. After the exposure, the platform may be moved up via a driving unit 122 controlled by a control unit 124 to give way for more resin to be photocured. The inflowing photocurable substance may be cured by the subsequent exposure. These steps may be repeated until the 3D object 118 has been generated in accordance with the projected layered images. Herein, a continuous printing mode or a stepwise printing mode may be realized. In a continuous printing mode the light sources may stay on, and the platform may be pulled up at a defined speed during illumination. In a stepwise printing mode, the light sources may be turned on while the platform is not moving subsequent to which the light sources may be turned off and the platformed moved up. For example, in one embodiment, the platform may be pulled up a relatively far distance (e.g. −5 mm, or between 4-6 mm) and then the platform may be subsequently lowered far enough to form a gap that corresponds to a thickness of the next layer of the 3D object to be printed. In another embodiment, the platform may be pulled up far enough to create a gap corresponding to the thickness of the next layer to be printed.

In the 3D printing system 100, the first light source 102 may be configured to emit a first light beam 126 having a first wavelength. The second light source 104 may be configured to emit a second light beam 126 having a second wavelength. The 3D printing system 100 may be configured to provide identical irradiation masks for both wavelengths, i.e., for both the photoinhibition and photopolymerization reactions. The 3D printing system 100 may further use only one optics (optical system 112) in the optical path 130 that projects the spatially structured superimposed light beam to an area of a photocurable substance (photosensitive resin) corresponding to a cross section of a 3D object being printed and may thus potentially prevent or reduce lingering inhibition radicals that may slow down printing speed. More specifically, the 3D printing system may comprise only one optical pathway 134 of the optical path 130, said optical pathway being disposed behind the DMD 110 and being dedicated to projecting the spatially structured superimposed light beam to the vat. Thus, a structured image may be projected to the vat for photoinhibition and photopolymerization by one optical system in the pathway 134 as opposed to a plurality of different structured images being projected by a plurality of different corresponding optical systems disposed in different corresponding pathways.

The 3D printing system may thus configure the DMD and the optical system 112 to confine photochemical activation and inhibition reactions of the polymerization process of the photosensitive resin to a region of the photosensitive resin corresponding to a cross section of an object being printed. Though the 3D printing system may have one optical system configured to project the spatially structured superimposed light beam, the 3D printing system may also comprise additional optical elements configured to form the light beams of the two light sources that impinge on the DMD, which optical elements may be placed in between the light sources and the dichroic mirror and/or between the dichroic mirror and the DMD.

The 3D printing system 100 may further comprise the dichroic mirror 106 disposed in an optical path 130 of the 3D printing system 100 and configured to superimpose the first and second beams. The 3D printing system 100 may also comprise the digital micromirror device 110 (DMD) configured to spatially structure the superimposed first and second light beams into a spatial pattern as a spatially structured superimposed light beam 108. An optical system 112 of the 3D printing system 100 may be configured to project the spatially structured superimposed light beam 108 onto the photosensitive resin 116 disposed in a vat 114 to independently control activation and inhibition of the polymerization process of the resin in a region 132 of the resin defined by the spatial pattern imposed by the DMD. The region 132 may be an area that corresponds to a layer or cross section of the object 118 being printed. The area may be illuminated, and a volume solidified may be defined by the area and the thickness of the layer to be printed. In the 3D printing system 100, the DMD may be disposed between the dichroic mirror 106 and the optical system 112. The optical system 112 may be configured to deliver a sharp image with defined size to the bottom of the vat 114. In some embodiments, the optical system 112 may comprise a plurality of lenses configured to tune sharpness and/or size of projected images.

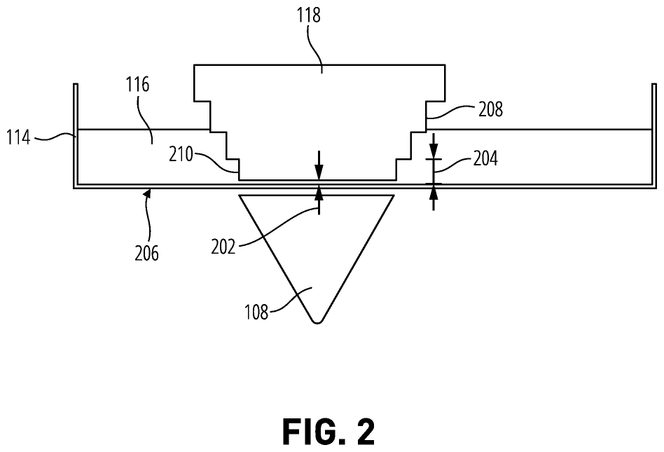

In the 3D printing system 100, the first wavelength of the first light source 102 may be configured to photochemically activate polymerization via a photo-initiator of the photosensitive resin 116 at a first volume extending above said region 132 of the resin defined by a first thickness 204. The second wavelength may be configured to inhibit said polymerization via a photo-inhibitor of the photosensitive resin at second volume extending above said region 132 which volume is defined by a second thickness 202 of the photosensitive resin 116, wherein said second volume is a “dead zone”. The second volume may be located adjacent to the bottom 206 of the vat 114 as shown in FIG. 2. The second thickness 202/dead zone thickness may be based on the resin properties selected (reactivities of initiator and inhibitor as well as absorption coefficients of the resin for the two wavelengths) and the relative light intensity of the first wavelength with respect to that of the second wavelength. The relative intensities may be controlled by the relative light output of the two light sources (i.e., the brightness of the LEDs, which may be controlled by the current powering the LEDs). In an aspect, the first and second light sources may alternatively be lamps or lasers. In that case, wavelength filtering or shifting may be needed. Lamps usually have broad wavelength spectra, and as such the wavelength needed for the system herein may be obtained (“cut out”) using filters. Lasers emitting in the desired wavelength may not be available, therefore laser light may need to be shifted in wavelength. In an example, exploiting phosphorescence in converters may an applicable technique. Of course, these exemplar embodiments are not meant to be limiting as other technical features may be readily apparent to one skilled in the art from the figures and descriptions.

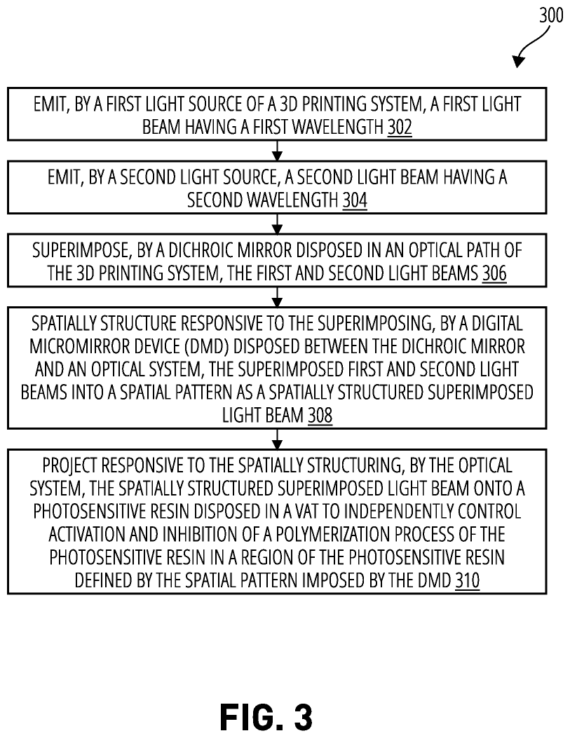

Turning now to FIG. 3, a process 300 of 3D printing an object is described. The process begins at step 302 wherein the process 300 may emit, by a first light source of the 3D printing system 100, a first light beam having a first wavelength. In step 304, process 300 may emit, by a second light source, a second light beam having a second wavelength. In step 306, process 300 may superimpose, by a dichroic mirror disposed in an optical path of the 3D printing system, the first and second light beams. In step 308, process 300 may spatially structure, by a digital micromirror device (DMD) disposed between the dichroic mirror and an optical system, the superimposed first and second light beams into a spatial pattern configured as a spatially structured superimposed light beam. In step 310, process 300 may project, using the optical system, the spatially structured superimposed light beam onto a photosensitive resin disposed in a vat to independently control activation and inhibition of a polymerization process of the photosensitive resin in a region of the photosensitive resin defined by the spatial pattern imposed by the DMD. Due to the photo-inhibition, a dead zone adjacent to the bottom of the vat may be present and may prevent the outermost layer at the interface between the resin and the bottom of the vat 210 of the 3D object being printed from sticking to the bottom of the vat. This process may be conducted continuously or in a stepwise manner as layers 208 are printed and the control unit 124 operates the driving unit 122 to move the platform 120 up and/or down to make way for subsequent outermost layers 210 to be printed without sticking to the bottom of the vat.

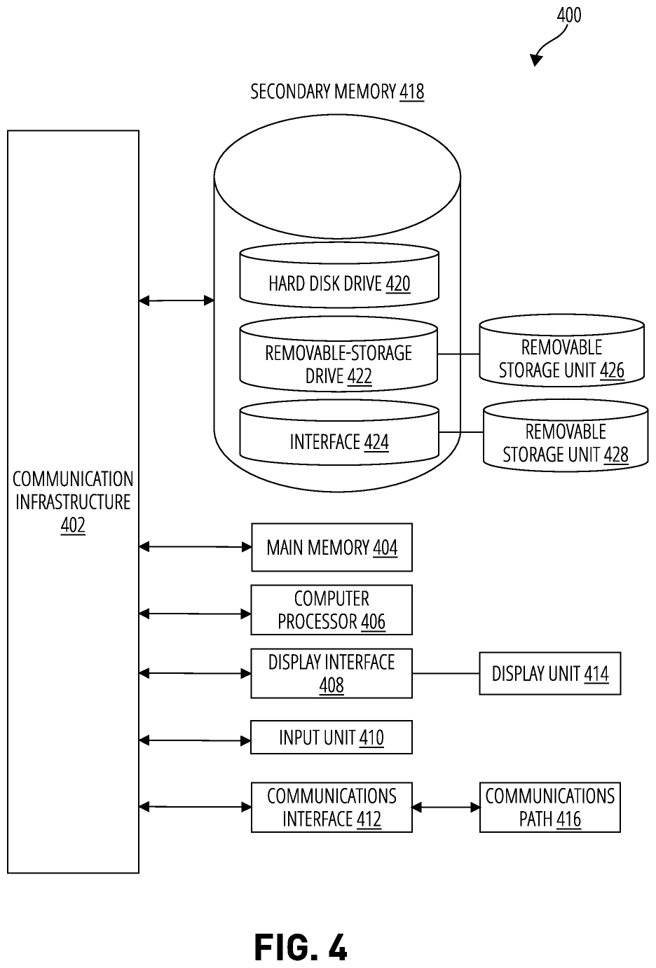

Having described the 3D printing system 100 and process 300, reference will now be made to FIG. 4, which shows a block diagram of a computer system 400 that may be employed in accordance with at least some of the illustrative embodiments herein. Although various embodiments may be described herein in terms of this exemplary computer system 400, after reading this description, it may become apparent to a person skilled in the relevant art(s) how to implement the disclosure using other computer systems and/or architectures.

In one example embodiment herein, at least some components of the 3D printing system 100 may form or be included in the computer system 400 of FIG. 4. For example, the computer processor 406 may form a part of or be the control unit 124 of FIG. 1. The computer system 400 includes at least one computer processor 406. The computer processor 406 may include, for example, a central processing unit (CPU), a multiple processing unit, an application-specific integrated circuit (“ASIC”), a field programmable gate array (“FPGA”), or the like. The computer processor 406 may be connected to a communication infrastructure 402 (e.g., a communications bus, a cross-over bar device, a network). In an illustrative embodiment herein, the computer processor 406 includes a CPU that that controls the 3D printing process, including moving the platform 120 after a layer is printed, operating the first and second light sources to emit light beams with defined wavelengths, and operating the DMDs to create spatially structured superimposed light beams that correspond to cross-sections of the 3D object to be printed.

The display interface 408 (or other output interface) may forward text, video graphics, and other data from the communication infrastructure 402 (or from a frame buffer (not shown)) for display-on-display unit 414. For example, the display interface 408 may include a video card with a graphics processing unit or may provide an operator with an interface for controlling the 3D printing apparatus.

The computer system 400 may also include an input unit 410 that may be used, along with the display unit 414 by an operator of the computer system 400 to send information to the computer processor 406. The input unit 410 may include a keyboard and/or touchscreen monitor. In one example, the display unit 414, the input unit 410, and the computer processor 406 may collectively form a user interface.

One or more steps of printing a 3D object, such as a 3D dental object, may be stored on a non-transitory storage device in the form of computer-readable program instructions. To execute a procedure, the computer processor 406 loads the appropriate instructions, as stored on storage device, into memory and then executes the loaded instructions.

The computer system 400 may further comprise a main memory 404, which may be a random-access memory (“RAM”), and also may include a secondary memory 418. The secondary memory 418 may include, for example, a hard disk drive 420 and/or a removable-storage drive 422 (e.g., a floppy disk drive, a magnetic tape drive, an optical disk drive, a flash memory drive, and the like). The removable-storage drive 422 reads from and/or writes to a removable storage unit 426 in a well-known manner. The removable storage unit 426 may be, for example, a floppy disk, a magnetic tape, an optical disk, a flash memory device, and the like, which may be written to and read from by the removable-storage drive 422. The removable storage unit 426 may include a non-transitory computer-readable storage medium storing computer-executable software instructions and/or data.

In further illustrative embodiments, the secondary memory 418 may include other computer-readable media storing computer-executable programs or other instructions to be loaded into the computer system 400. Such devices may include removable storage unit 428 and an interface 424 (e.g., a program cartridge and a cartridge interface); a removable memory chip (e.g., an erasable programmable read-only memory (“EPROM”) or a programmable read-only memory (“PROM”)) and an associated memory socket; and other removable storage units 428 and interfaces 424 that allow software and data to be transferred from the removable storage unit 428 to other parts of the computer system 400.

The computer system 400 may also include a communications interface 412 that enables software and data to be transferred between the computer system 400 and external devices. Such an interface may include a modem, a network interface (e.g., an Ethernet card or an IEEE 802.11 wireless LAN interface), a communications port (e.g., a Universal Serial Bus (“USB”) port or a FireWire® port), a Personal Computer Memory Card International Association (“PCMCIA”) interface, Bluetooth®, and the like. Software and data transferred via the communications interface 412 may be in the form of signals, which may be electronic, electromagnetic, optical or another type of signal that may be capable of being transmitted and/or received by the communications interface 412. Signals may be provided to the communications interface 412 via a communications path 416 (e.g., a channel). The communications path 416 carries signals and may be implemented using wire or cable, fiber optics, a telephone line, a cellular link, a radiofrequency (“RF”) link, or the like. The communications interface 412 may be used to transfer software or data or other information between the computer system 400 and a remote server or cloud-based storage (not shown).

One or more computer programs or computer control logic may be stored in the main memory 404 and/or the secondary memory 418. The computer programs may also be received via the communications interface 412. The computer programs include computer-executable instructions which, when executed by the computer processor 406, cause the computer system 400 to perform the methods as described hereinafter. Accordingly, the computer programs may control the computer system 400 and other components of the 3D printing apparatus.

In another embodiment, the software may be stored in a non-transitory computer-readable storage medium and loaded into the main memory 404 and/or the secondary memory 418 using the removable-storage drive 422, hard disk drive 420, and/or the communications interface 412. Control logic (software), when executed by the computer processor 406, causes the computer system 400, and more generally the 3D Printing system 100, to perform the some or all of the methods described herein.

Lastly, in another example embodiment hardware components such as ASICs, FPGAs, and the like, may be used to carry out the functionality described herein. Implementation of such a hardware arrangement so as to perform the functions described herein will be apparent to persons skilled in the relevant art(s) in view of this description.

What is claimed is:

1. A 3D printing system comprising:
a first light source configured to emit a first light beam having a first wavelength;
a second light source configured to emit a second light beam having a second wavelength;
a dichroic mirror disposed in an optical path of the 3D printing system and configured to superimpose the first and second beams;
a digital micromirror device (DMD) configured to spatially structure the superimposed first and second light beams into a spatial pattern as a spatially structured superimposed light beam; and
an optical system configured to project the spatially structured superimposed light beam onto a photosensitive resin disposed in a vat to independently control activation and inhibition of a polymerization process of the photosensitive resin in a first and second volume respectively, above a region of the photosensitive resin defined by the spatial pattern imposed by the DMD
wherein the DMD is disposed between the dichroic mirror and the optical system.

2. The 3D printing system of claim 1, wherein the first wavelength is configured to photochemically activate polymerization via a photo-initiator of the photosensitive resin at a first volume above said region of the resin and the second wavelength is configured to inhibit said polymerization via a photo-inhibitor of the photosensitive resin at a second volume above said region of the photosensitive resin,
wherein said second volume is a dead zone adjacent to a bottom of the vat and wherein said second volume has a dead zone thickness defined by at least a relative intensity of the first and second light beams.

3. The 3D printing system of claim 2, wherein the first wavelength is about 385 nm and the second wavelength is about 405 nm.

4. The 3D printing system of claim 2, wherein the dead zone thickness is a factor of reactivities of the photo-initiator and photo-inhibitor as well as absorption coefficients of the photosensitive resin for the first and second wavelengths.

5. The 3D printing system of claim 1, further comprising the photosensitive resin that comprises a photo-inhibitor and a photo-initiator.

6. The 3D printing system of claim 1, wherein the DMD is configured to confine photochemical activation and inhibition reactions of the polymerization process of the photosensitive resin to an area of the photosensitive resin corresponding to a cross section of an object being printed.

7. The 3D printing system of claim 6, wherein the object is a 3D dental object.

8. The 3D printing system of claim 1, wherein the 3D printing system is configured to provide identical irradiation masks for both the activation and the inhibition of the polymerization.

9. The 3D printing system of claim 1, wherein the first and second light sources are LEDs (light emitting diodes).

10. The 3D printing system of claim 1, wherein the first and second light sources are lamps or lasers.

11. The 3D printing system of claim 1, wherein the 3D printing system comprises only one optical pathway in which the spatially structured superimposed light beam is projected to the vat.

12. The 3D printing system of claim 1, wherein an emittance spectrum of the first light source providing the first wavelength does not overlap or does not overlap significantly with the emittance spectrum of the second light source providing the second wavelength.

13. A method comprising:
emitting, by a first light source of a 3D printing system, a first light beam having a first wavelength;
emitting, by a second light source, a second light beam having a second wavelength;
superimposing, by a dichroic mirror disposed in an optical path of the 3D printing system, the first and second light beams;
spatially structuring, by a digital micromirror device (DMD) disposed between the dichroic mirror and an optical system, the superimposed first and second light beams into a spatial pattern as a spatially structured superimposed light beam; and
projecting, by the optical system, the spatially structured superimposed light beam onto a photosensitive resin disposed in a vat to independently control activation and inhibition of a polymerization process of the photosensitive resin in a first and second volume respectively, above a region of the photosensitive resin defined by the spatial pattern imposed by the DMD.

14. A non-transitory computer readable storage medium storing a program which, when executed by a computer system, causes the computer system to perform a procedure comprising:
emitting, by a first light source of a 3D printing system, a first light beam having a first wavelength;
emitting, by a second light source, a second light beam having a second wavelength;
superimposing, by a dichroic mirror disposed in an optical path of the 3D printing system, the first and second light beams;
spatially structuring, by a digital micromirror device (DMD) disposed between the dichroic mirror and an optical system, the superimposed first and second light beams into a spatial pattern as a spatially structured superimposed light beam; and
projecting, by the optical system, the spatially structured superimposed light beam onto a photosensitive resin disposed in a vat to independently control activation and inhibition of a polymerization process of the photosensitive resin in a first and second volume respectively, above a region of the photosensitive resin defined by the spatial pattern imposed by the DMD.
